(19) United States
(12) Patent Application Publication
(10) Pub. No.: US 2005/0165712 A1
(43) Pub. Date: Jul. 28, 2005

(54) Method for operating software object using natural language and program for the same

(76) Inventors: Shuichi Araki, Otsu-shi (JP); Michio Ogura, Kyoto-shi (JP)

Correspondence Address: OLIFF & BERRIDGE, PLC, P.O. BOX 19928, ALEXANDRIA, VA, 22320, US

(21) Appl. No.: 10/508,173

(22) PCT Filed: Dec. 9, 2002
(86) PCT No.: PCT/JP02/12882

(30) Foreign Application Priority Data
Mar. 19, 2002 (JP) 2002-076319

(51) Int. Cl. G06F 7/00

(52) U.S. Cl. 707/1

(57) ABSTRACT

The present invention provides a natural language interface having versatility for allowing unified operation of different software objects and flexibility for appropriately processing an input even when it is a natural language expression of a request, desire or intension of a user. According to the present invention, a character string of natural language entered is parsed as an expression of the user's request, and a software object most suitable for carrying out a process corresponding to the request is selected. A function description expression for making the software object carry out the aforementioned process is intermediately created. Then, the function description expression is converted into an instruction sequence that can be executed by an OS or a program.

### TECHNICAL FIELD

The present invention relates to a method of operating a software object operable on a computer, using natural language, and a program for such a method. In this specification, a software object means either an operating system (OS) for controlling electronic apparatuses, such as personal computers or microcomputer-controlled devices, or an application program operable on the OS. Also, in this specification, a system that is constructed to receive signals from an input device (a keyboard, a microphone, a handwriting tablet, etc.) to create a character string of natural language, parse the character string, and create operational instructions for a software object on the basis of the analysis result, is called a “natural language interface.”

### BACKGROUND ART

For years, many people have conducted intensive researches on natural language interfaces for operating software objects with natural language. Examples include the handwriting input method and device disclosed in the Japanese Unexamined Patent Publication No. H8-147096, the information processor disclosed in the Japanese Unexamined Patent Publication No. H6-75692, the information input device disclosed in the Japanese Unexamined Patent Publication No. H6-131108 and the information input device disclosed in the Japanese Unexamined Patent Publication No. H6-282566. These conventional natural language interfaces are used to call the built-in functions of a software object with natural language. For example, the Japanese Unexamined Patent Publication No. H6-75692 discloses a word processor that converts a specified character string into double-sized characters when a user writes the word “enlarge” on the handwriting input device. The Japanese Unexamined Patent Publication H8-147096 discloses a videocassette recorder having a control system that starts the recording operation when a user writes the word “record” on the handwriting input device.

These conventional natural language interfaces are each designed for a specific type of software object, such as a word processor program or a control program for a videocassette recorder, which are not basically designed on the assumption that a natural language interface developed for a given software object might be also used for another type of software object. Therefore, when a natural language interface is needed for a certain software object, it is necessary for software developers to spend much energy to develop a newly dedicated natural language interface.

Moreover, for the conventional natural language interfaces, it is assumed that users should enter instructions for calling built-in functions prepared beforehand for the software object. Therefore, the user must have information (or knowledge) beforehand about what functions the software object has and what kinds of natural language should be used to call those functions. This means that the user should give instructions in compliance with the functions of the software object, rather than the software object working in response to the request from the user. Remaining in such a form of implementation will inevitably reduce the flexibility in the operation of the software object with natural language. For example, suppose that a user thinks “I want to create a notice of a movie show”, and enters the phrase that expresses the idea as it is. The phase “I want to create a notice of a movie show” is not an instruction for explicitly calling a certain function of the software object, but an expression of the request, desire or intension of the user. The conventional natural language interfaces cannot appropriately process such an input.

The present invention addresses the above-described problems, an object of which is to provide a kind of technology for realizing a natural language interface having versatility for allowing unified operation of different software objects and flexibility for appropriately processing an input received in the form of a natural language expression of the request, desire or intension of the user.

### DISCLOSURE OF THE INVENTION

To solve the above-described problems, the present invention provides a method of operating a software object using natural language, which is characterized by enabling a computer to execute a process including steps of:
receiving a character string of natural language expressing a request from a predetermined input means;
parsing the words or sentence expressed by the character string to create a semantic expression;
selecting a software object most suitable for carrying out an operation corresponding to the request, based on the semantic expression, and setting an environment for operating the software object;
translating the semantic expression into a function description expression composed of normalized words corresponding to operational instructions to be given to the software object to control the software object to carry out the operation corresponding to the request;
creating an instruction executable for the software object from the function description expression, and sending the instruction to the software object; and
outputting the result of the operation carried out by the software object in response to the instruction in a predetermined form recognizable to the user.

Also, the present invention provides a program for enabling a computer to carry out the above-described operations.

The process steps according to the present invention are described concretely, referring to the drawings.

The first step is to receive a character string of natural language entered by a user through an input means of a computer (Step 50). The input means is constructed by using a hardware device, such as a keyboard, a handwriting input device or a voice input device, and a software program for converting output signals of the hardware device into a character string of natural language (such as a keyboard driver, a pattern recognition software program, or a voice recognition software program). Here, it is assumed that the character string entered is “I want to create a notice of a movie show.”

The next step is to parse the character string generated as described above and create a semantic expression (Step 51). This process can be carried out by a well-known natural language processing method including the morphological analysis, the syntactic analysis, the semantic analysis and other steps. It is assumed that the semantic expression created hereby includes “(I) want”, “(to) create”, “a notice”, “(of) a movie show.”

The next step is to select a software object most suitable for carrying out a process corresponding to the user's request, based on the aforementioned semantic expression (Step 52). The selection of the software object is performed using a dictionary (called the “environment setting unit dictionary” hereinafter), which associates semantic expressions with software objects. An example of the environment setting unit dictionary is shown in FIG. 2. From the semantic expression “(I) want”, “(to) create”, “a notice”, “(of) a movie show”, the dictionary shown in FIG. 2 gives the following rating for each software object:
Word Processor=1.7
E-mail Client=0.2
Drawing Software=0.2

As a result, the software object with the highest rating, i.e. “word processor”, is selected as the most suitable. Here, the software object with the highest rating may be selected automatically, or the selection of the software object may be done after the user's approval.

The next step is to set up an environment for operating the software object selected as described above (Step 53). More specifically, the semantic expression is translated into a functional description expression, using a dictionary for translating the functions of software objects into normalized words (which is called the “function translation unit dictionary” hereinafter). An example of the function translation unit dictionary is shown in FIG. 3. The function translation unit dictionary 50 shown in FIG. 3 is a conversion table defining conversion pairs each specifying an input word and an output word (or translation) that can replace the input word. This conversion table shows that an input word “create” can be converted into an output word “make.” Furthermore, in the example of FIG. 3, each conversion pair is provided with additional information including the type of input word and the rating indicating the suitability of conversion for each output word. This information is used for selecting a suitable output word when a given input word has two or more possible output words. The rating dynamically changes in the course of the operation.

Detailed steps of converting (or translating) an input word into an output word using the dictionary shown in FIG. 3 is described. Taking the word “create” as an example, this word is first translated into “make”, which can be translated into one of “compose a text document”, “construct a drawing” and “write an e-mail.” In the present case, the word processor is selected as the software object, so that the rating for “compose a text document” is the highest. As a result, “compose a text document” is selected automatically (or after the user's approval) as the translation. “Compose a text document” is further translated into “start a word processor/create a new text document”, which has no entry for itself in the dictionary. As a result, “start a word processor/create a new text document” is chosen as the function description expression for “make.” Similarly, each word of the semantic expression “(I) want”, “(to) create”, “a notice”, “(of) a movie show” is recursively translated into function description expressions “start a word processor”, “create a new text document” and “an invitation to a movie show.”

The next step is to create and execute instructions for operating the software object from the above-mentioned functional description expressions (Step 54). For example, for the functional description expression “start a word processor”, an instruction sequence for loading the word processor program from a predetermined location on a hard disk and running the program is created and passed to the OS for execution. For the functional description expression “create a new text document”, an instruction sequence for calling the function for creating a new text document is created and passed through the OS to the word processor program for execution. The instruction sequence to be passed to the OS should be created in accordance with the application programming interface (API) specifications of the OS, and the instruction sequence to be passed to the word processor program should be created in accordance with the API specifications of the word processor program. Examples of the instructions sequence include a command line for running the program and a script for using various functions within the environment of the running program.

The next step is to output the result of the execution of the instruction sequence by the OS or software object in a predetermined form recognizable to the user. For example, when the instruction for “start a word processor” has been duly executed, a window for the word processor is displayed on the foreground of the screen of the computer (Step 55). Also, when the instruction for “create a new text document” has been duly executed, a blank text document is created within the window of the word processor. When the operation cannot be duly performed, a predetermined error handling is carried out (Step 56).

As described above, the present invention provides a fundamental architecture for automatically selecting a software object most suitable for carrying out the process corresponding to the user's request entered with natural language, and then creating an appropriate instruction sequence for operating the software object. The present invention thus constructed provides an easier way for linking software objects with natural language interfaces. That is, a mechanism for operating a software object with natural language can be easily constructed by defining an instruction sequence for operating the software object and creating a dictionary that associates each instruction sequence with a functional description expression.

In conventional methods, a character string of natural language entered is regarded as an instruction from the user, and this instruction corresponds to the function description expression in the present invention. The method according to the present invention, on the other hand, regards a character string of natural language as a request from the user and parses the character string, using various dictionaries, to intermediately create a function description expression for the software object. In other words, in conventional cases, users need to express, in words, what functions of the software object they want to use. The present invention, on the other hand, allows users to express what they want to do. Therefore, even if a user does not know in advance what kinds of software object are available and what functions each software object has, the user can operate the software objects by directly expressing, in words, what she or he wants to do.

### BRIEF DESCRIPTION OF THE DRAWINGS

FIG. 1 is a flow chart showing an example of the steps of operating a software object by the method according to the present invention.

FIG. 2 is an example of the structure of an environment setting unit dictionary.

FIG. 3 is an example of the structure of a function translation unit dictionary.

FIG. 4 is a block diagram showing the hardware construction of a computer system as an embodiment of the present invention.

FIG. 5 is a block diagram showing the functional construction of the natural language interface constructed according to the present invention.

FIG. 6 is a flow chart showing another example of the steps of operating a software object by the method according to the present invention.

### BEST MODE FOR CARRYING OUT THE INVENTION

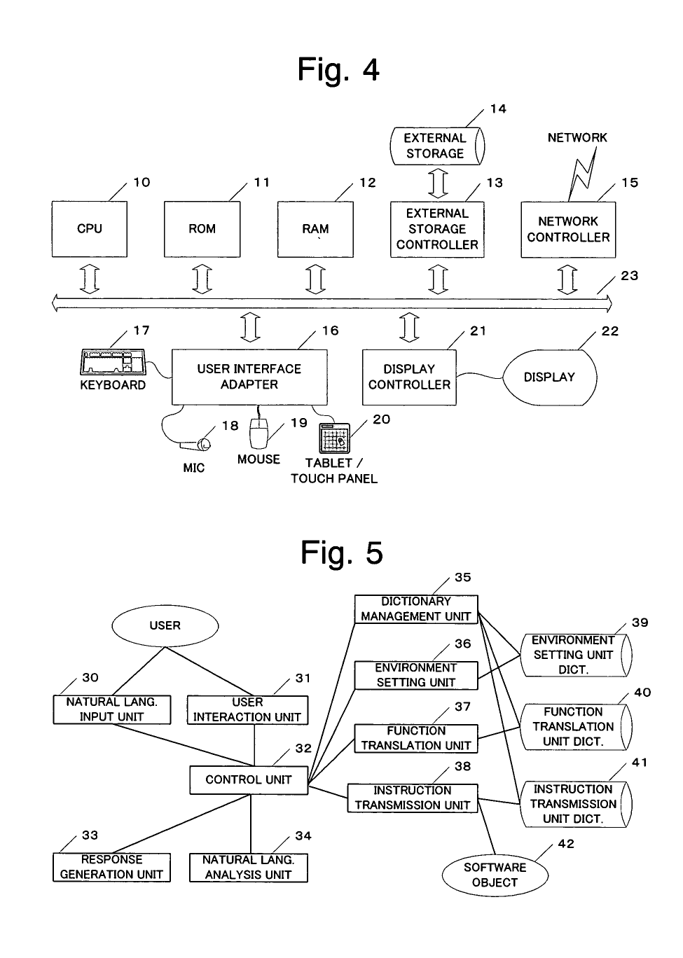

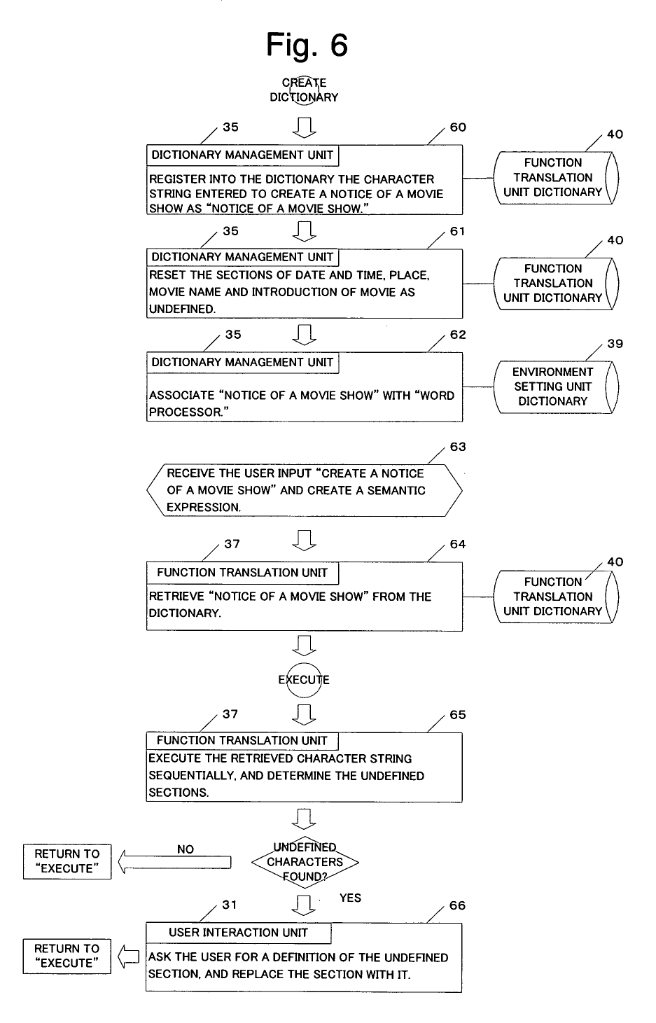

FIG. 4 shows the schematic construction of an example of a computer system equipped with a natural language interface constructed according to the present invention. This computer system, including a commonly used personal computer, and has a central processing unit (CPU) 10, a read-only memory (ROM) 11, a random access memory (RAM) 12, an external storage controller 13 with an external storage (or auxiliary storage) 14, a network controller 15 for communication with external systems, a user interface adapter 16, a display controller 21 and a display 22. Various input devices (a keyboard 17, a microphone 18 for voice input, a mouse 19 and a tablet 20 for handwriting input) for inputting a series of words are connected to the user interface adapter 16.

FIG. 5 shows the functional construction of the system of the present embodiment. In FIG. 5, the natural language input unit 30 is a means for receiving a word, a series of words or a sentence (which are generally referred to as “the words” hereinafter) as input and creating a character string representing the words. The method of the input of the words can be selected from the following choices: key input, using the keyboard 17; voice input, using the microphone 18; character input panel on the screen, operable with the mouse 19; and handwriting input, using the tablet 20. Of course, it is possible to use another method of the input of the words as long as an input device with a corresponding software program (driver) is available.

The natural language analysis unit 34 has the functions of analyzing natural language, parsing a character string by using the dictionaries, interactively creating a syntactic sentence, and managing category dictionaries. It parses the above-mentioned character string to create a semantic expression. For the parsing of character strings, the technologies generally known in the field of natural language processing can be used. For example, well-known natural language analysis engines include “ChaSen” developed by the Nara Institute of Science and Technology and “KNP” developed by Kyoto University, and these existing engines can be used to construct the natural language analysis unit 34.

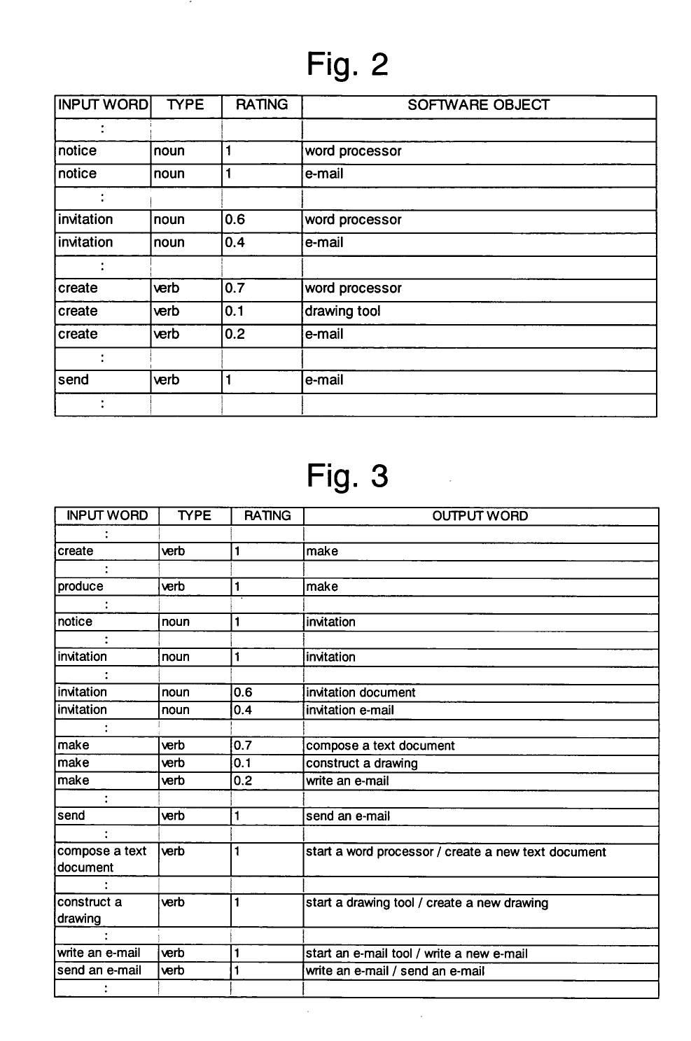

The environment setting unit 36 searches the environment setting unit dictionary 39 (FIG. 2) for all the concepts present in the semantic expression, chooses a software object most suitable for carrying out the process corresponding to the user's request, and sets up an environment for operating the software object. The environment setting unit dictionary 39 contains information for associating the concepts used in semantic expressions with the software objects available on the system and information about the method of setting an environment for each software object. The environment setting includes the setup of the dictionaries used in the subsequent processes and the setup of the environment within the apparatus in which the software object works. In the case the environment setting method is described with natural language, the natural language analysis unit 34 carries out the operations in a recursive manner.

The function translation unit 37 searches the function translation unit dictionary 40 (FIG. 3) for all the concepts present in the semantic expression, and replaces each concept with a functional description expression suitable for the function of the software object stored in the dictionary. This replacing process is recursively performed through the natural language analysis unit 34 because there is a possibility that the natural language itself is registered in the dictionary. The function description expression created finally is a semantic expression consisting of normalized words. If any entry is left undefined in the dictionary, the function translation unit 37 receives a definition for that entry from the user through the user interaction unit 31.

The instruction transmission unit 38 searches the instruction transmission unit dictionary 41 for all the concepts present in the functional description expression created by the function translation unit 37, and creates an instruction sequence for executing a function of the software object 42 stored in the dictionary. For example, the instruction sequence may be an API of the software object 42 and its parameters, or a sequence of commands passed through a command stream. The instruction transmission unit 38 executes the instruction sequence and executes the function of the software object 42.

The response generation unit 33 receives the result of execution of the software object 42 conducted by the instruction transmission unit 38, and makes a response in the form desired by the user. The response can take various forms, such as showing on the display 22, printing with a printer (not shown), storing information in a database or controlling an apparatus. If the result obtained by executing the function of the software object 42 is too unsatisfactory to make a response in the desired form, the response generation unit 33 shows the user a message through the user interaction unit 31 and, if necessity, asks the user for directions.

The dictionary management unit 35 carries out the creation of new information for the environment setting unit dictionary 39, the function translation unit dictionary 40 and the instruction transmission unit dictionary 41, as well as the changing, deleting and viewing of information stored in these dictionaries. The control unit 42 sends/receives necessary data to/from the natural language input unit 30, the natural language analysis unit 34, the environment setting unit 36, the function translation unit 37, the instruction transmission unit 38, the response generation unit 33, the user interaction unit 31, and the dictionary management unit 35, and controls their operations.

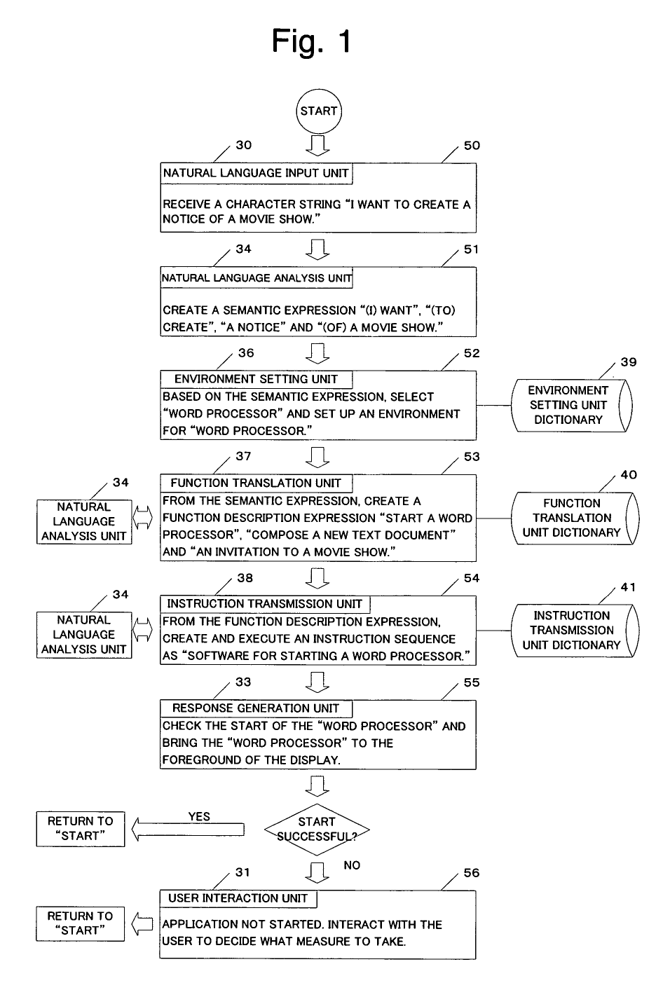

The steps of processing the character string “I want to create a notice of a movie show” with the system of the present embodiment is described, referring to FIGS. 1-3.

When a user, intending to create a notice of a movie show, enters a sentence “I want to create a notice of a movie show” through the keyboard 17, the natural language input unit 30 receives the character string “I want to create a notice of a movie show” through the keyboard input interface (Step 50). This character string is passed to the natural language analysis unit 34.

The natural language analysis unit 34 parses the character string received and creates a semantic expression consisting of, for example, four words syntactically and semantically separated from each other: “(I) want”, “(to) create”, “a notice”, “(of) a movie show” (Step 51). This semantic expression is passed to the environment setting unit 36.

Based on the environment setting unit dictionary 39 (FIG. 2), the environment setting unit 36 rates each software object with respect to the above-mentioned four words and, determining that the software object with the highest comprehensive rating is the “word processor”, carries out the environment-setting process for “word processor”, which is stored in the environment setting unit dictionary 39 (Step 52). The environment-setting process includes the configuration of the function translation unit dictionary 40 and the instruction transmission unit dictionary 41 as well as the check and reservation of the computer resources.

Based on the function translation unit dictionary 40 (FIG. 3), the function translation unit 37 translates the semantic expression into a functional description expression by replacing each of the above-mentioned four words with a function provided by the software object or a combination of such functions (Step 53). For example, “make” has two possible output words (or translations), i.e. “compose a text document” and “construct a drawing.” In the present case, it is converted into “compose a text document” because the rating of “compose a text document” is the highest. Thus, using the function translation unit dictionary 40 shown in FIG. 3, the function translation unit 37 recursively performs the searching and replacing process on the semantic expression “(I) want”, “(to) create”, “a notice”, “(of) a movie show” to create a function description expression “start a word processor”, “create a new text document” and “an invitation to a movie show.” During the recursive searching and replacing process, the semantic expression is dynamically changed, using the natural language analysis unit 34.

Next, the instruction transmission unit 38 creates an instruction sequence, using the instruction transmission unit dictionary 41 (Step 54). Taking “start a word processor” as an example, the natural language analysis unit 34 parses this character string and splits it into “start” and “a word processor.” Next, the instruction transmission unit 38 searches the instruction transmission unit dictionary 41 for these concepts to create an instruction sequence. In the present case, “start” is replaced with an executable software program for starting a specific word processor application through the APIs of the operating system, and the instruction transmission unit 38 executes the program. The creation of instruction sequence also includes the recursive searching and replacing as well as the dynamic changing of the semantic expression using the natural language analysis unit 34.

Next, the response generation unit 33 checks that the word processor has started and brings the word processor to the foreground of the display (Step 55). If the word processor has failed to start due to some problem, the response generation unit 33 interacts with the user through the user interaction unit 31 to decide what measure should be taken (Step 56). After the word processor starts running, the user creates a document by entering words consecutively that express what she or he wants to do (i.e. his/her requests). For examples, the words entered may be “put the title ‘notice of a movie show’” or “emphasize the title.” Entering the word “end” terminates the program.

In the previous example, “a notice of a movie show” was created by a series of natural language inputs performed by the user. The following description shows the steps of registering into the system the operation steps of creating the above “notice” to facilitate the reproductions of similar “notices.” For example, suppose that the goal to be achieved hereby is to create a “notice” which allows the date and time, the place, the movie name and the introduction of the movie to be freely changed.

The first step is to register the function description expression corresponding to the above-described series of operations with the function translation unit dictionary 40 through the dictionary management unit 35, with an appropriate name, which is “notice of a movie show” in the present example (Step 60).

Next, within the character string included in the aforementioned series of function description expression registered in the function translation unit dictionary 40, the sections corresponding to the date and time, the place, the movie name and the introduction of the movie are reset as undefined sections (Step 61).

Next, the character string “notice of a movie show” is associated with the word processor object through the dictionary management unit 35 and registered into the environment setting unit dictionary 39 (Step 62).

After the entry for “notice of a movie show” is added to the function translation unit dictionary 40 and the environment setting unit dictionary 39, when the user enters the natural language “create a notice of a movie show” through the natural language input unit 30, the natural language analysis unit 34 and the environment setting unit 36 carries out the same processing as in the example of FIG. 1 to create a semantic expression (Step 63).

The next step is to translate the semantic expression into a function description expression, where the function translation unit 37 replaces “notice of a movie show” with the series of functional description expression registered previously into the function translation unit dictionary 40, and recursively translates the functional description expression as described above (Step 64). On finding an undefined section (date and time, place, name of movie or introduction of movie) included in the functional description expression (Step 65), the function translation unit 37 asks the user for a definition for that section. When the user enters some words (or character string) corresponding to the definition, the function translation unit 37 replaces the undefined section with those words (Step 66). Thus, the user can easily create a notice of a movie show by entering the date and time, the place, the movie name and the introduction of the movie along with guidance of the user interaction unit 31, It should be noted that the embodiment of the present invention is not limited to the above-described one. For example, in the above-described embodiment, plural application software objects installed in a personal computer are operated through the natural language interface. It is also possible to construct the system so that plural network-compliant electronic apparatuses (including computers) linked to a local area network, the Internet or other network can be operated through a natural language interface of a controller connected to the same network. Therefore, for example, it will be possible to realize a system having a voice input type controller for network-compliant electric appliances connected to a local area network installed in a home.

1. A method of operating a software object using natural language, which is characterized by enabling a computer to execute a process including steps of:
receiving a character string of natural language expressing a request from a predetermined input means;
parsing a word or sentence expressed by the character string to create a semantic expression;
selecting a software object most suitable for carrying out an operation corresponding to the request, based on the semantic expression, and setting an environment for operating the software object;
translating the semantic expression into a function description expression composed of normalized words corresponding to operational instructions to be given to the software object to control the software object to carry out an operation corresponding to the request;
creating an instruction executable for the software object from the function description expression, and sending the instruction to the software object; and
outputting a result of the operation carried out by the software object in response to the instruction in a predetermined form recognizable to the user.

2. A program for enabling a computer to execute a process according to the method described in claim 1.
